(19) United States
(12) Patent Application Publication
(10) Pub. No.: US 2007/0071147 A1
(43) Pub. Date: Mar. 29, 2007

(54) Pseudo eigen-beamforming with dynamic beam selection

(76) Inventors: Hemanth Sampath, San Diego, CA (US); Dhananjay Ashok Gore, San Diego, CA (US); Alexei Gorokhov, San Diego, CA (US); Jibing Wang, San Diego, CA (US); Tamer Kadous, San Diego, CA (US)

Correspondence Address: QUALCOMM INCORPORATED, 5775 MOREHOUSE DR., SAN DIEGO, CA, 92121, US

(21) Appl. No.: 11/454,761

(22) Filed: Jun. 15, 2006

Related U.S. Application Data
(60) Provisional application No. 60/691,459, filed on Jun. 16, 2005.

(51) Int. Cl. H04B 7/10; H04L 27/28

(52) U.S. Cl. 375/347; 375/260

(57) ABSTRACT

Techniques for transmitting data with limited channel information are described. A transmitter (e.g., a base station) obtains channel information for a subset of multiple antennas used for data reception at a receiver (e.g., a terminal). The channel information may include at least one channel response vector for at least one antenna, which is a subset of the multiple antennas at the receiver. The transmitter derives multiple eigenvectors based on the channel information, e.g., using pseudo eigen-beamforming. The transmitter selects at least one eigenvector from among the multiple eigenvectors and transmits data with the selected eigenvector(s). The transmitter may select and use different subsets of eigenvector(s) in different time intervals. The transmitter may arrange the multiple eigenvectors into multiple sets based on their eigenvalues, select at least one set based on a MIMO transmission rank, and select one eigenvector from each set.

### CLAIM OF PRIORITY UNDER 35 U.S.C. §119

The present application claims priority to provisional U.S. Application Ser. No. 60/691,459, entitled “RANDOM BEAM SELECTION TO SUPPORT PSEUDO-EBF BASED ON TRANSMIT CORRELATION MATRIX,” filed Jun. 16, 2005, and assigned to the assignee hereof and hereby expressly incorporated by reference herein.

### BACKGROUND

I. Field

The present disclosure relates generally to communication, and more specifically to techniques for transmitting data in a multiple-input multiple-output (MIMO) system.

II. Background

In a wireless communication system, a transmitter may utilize multiple (T) transmit antennas for data transmission to a receiver equipped with multiple (R) receive antennas. The multiple transmit and receive antennas form a MIMO channel that may be used to increase throughput and/or improve reliability. For example, the transmitter may transmit up to T data streams simultaneously from the T transmit antennas to improve throughput. Alternatively, the transmitter may transmit a single data stream from all T transmit antennas to improve reception by the receiver.

Improved performance may be achieved by transmitting data streams on the eigenmodes of the MIMO channel. The eigenmodes may be viewed as orthogonal spatial channels. To transmit data on the eigenmodes, the transmitter derives a beamforming matrix based on a MIMO channel response matrix and performs eigen-beamforming with the beamforming matrix. However, in many cases, the transmitter may have limited information on the MIMO channel response and may not be able to derive the beamforming matrix. Nevertheless, it is desirable to use the limited channel information to achieve good performance for data transmission.

There is therefore a need in the art for techniques to transmit data with limited channel information.

### SUMMARY

Techniques for transmitting data with limited channel information are described herein. In an embodiment, a transmitter (e.g., a base station) obtains channel information for a subset of multiple antennas used for data reception at a receiver (e.g., a terminal). The channel information may comprise at least one channel response vector for at least one antenna, which is a subset of the multiple antennas at the receiver. The transmitter derives multiple eigenvectors based on the channel information, e.g., using pseudo eigen-beamforming techniques described below. The transmitter selects at least one eigenvector from among the multiple eigenvectors and transmits data with the selected eigenvector(s). Each eigenvector corresponds to a beam. The transmitter may select and use different subsets of eigenvector(s) in different time intervals. In an embodiment, the transmitter arranges the multiple eigenvectors into multiple sets (e.g., based on eigenvalues for these eigenvectors), selects at least one set based on a MIMO transmission rank, and selects one eigenvector from each selected set.

In an embodiment, the receiver receives symbols for the data transmission sent via a MIMO channel to the multiple antennas at the receiver. The receiver determines an effective channel response matrix formed by a channel response matrix for the MIMO channel and the eigenvector(s) used for data transmission. The receiver performs MIMO detection on the received symbols with the effective channel response matrix. The receiver may also determine and send to the transmitter the MIMO transmission rank, at least one channel quality indicator (CQI) for the MIMO channel, and possibly other information

Various aspects and embodiments of the invention are described in further detail below.

### BRIEF DESCRIPTION OF THE DRAWINGS

Aspects and embodiments of the invention will become more apparent from the detailed description set forth below when taken in conjunction with the drawings in which like reference characters identify correspondingly throughout.

FIG. 1 shows a block diagram of a base station and a terminal.

FIG. 2A shows forward link transmission from the base station to the terminal.

FIG. 2B shows reverse link transmission from the terminal to the base station.

FIG. 3 shows a process for transmitting data.

FIG. 4 shows an apparatus for transmitting data.

FIG. 5 shows a process for receiving data.

FIG. 6 shows an apparatus for receiving data.

FIG. 7 shows a block diagram of the transmit portion of the base station.

FIG. 8 shows a block diagram of the receive portion of the terminal.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The transmission techniques described herein may be used for various wireless communication systems such as Frequency Division Multiple Access (FDMA) systems, Code Division Multiple Access (CDMA) systems, Time Division Multiple Access (TDMA) systems, Spatial Division Multiple Access (SDMA) systems, Orthogonal FDMA (OFDMA) systems, Single-Carrier FDMA (SC-FDMA) systems, and so on. An OFDMA system utilizes Orthogonal Frequency Division Multiplexing (OFDM). An SC-FDMA system utilizes Single-Carrier Frequency Division Multiplexing (SC-FDM). OFDM and SC-FDM partition the system bandwidth into multiple (K) orthogonal subcarriers, which are also called tones, bins, and so on. Each subcarrier may be modulated with data. In general, modulation symbols are sent in the frequency domain with OFDM and in the time domain with SC-FDM. For clarity, the transmission techniques are described below for an OFDM-based system, e.g., an OFDMA system.

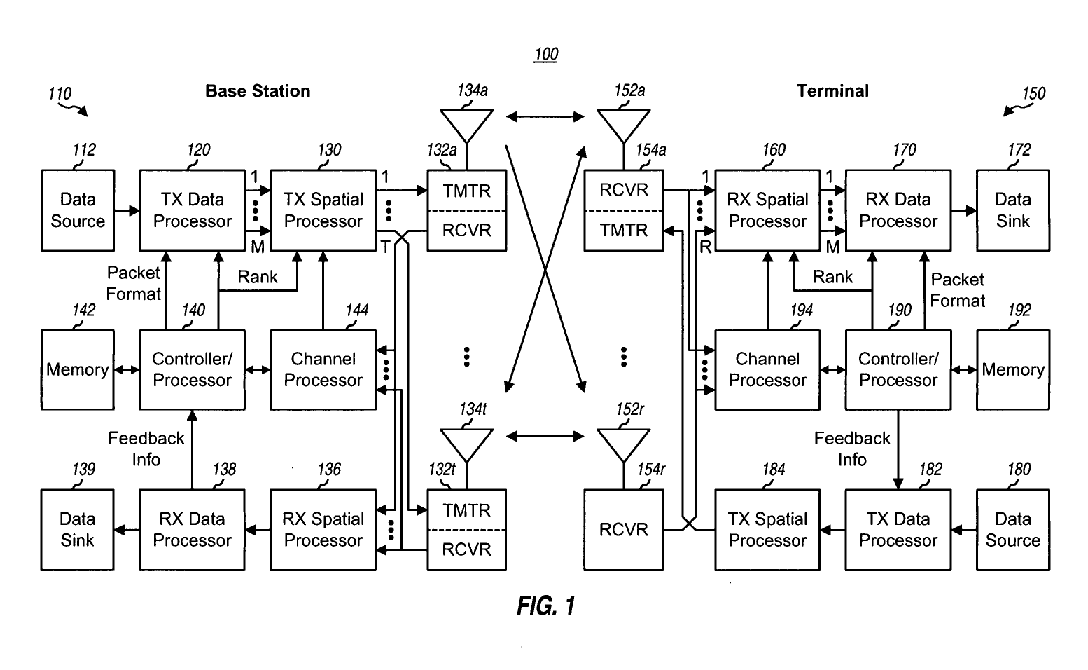

FIG. 1 shows a block diagram of an embodiment of a base station 110 and a terminal 150 in a wireless communication system 100. A base station may also be referred to as, and may contain some or all of the functionality of, an access point, a Node B, and/or some other network entity. A terminal may also be referred to as, and may contain some or all of the functionality of, a mobile station, a user equipment, a subscriber unit, and/or some other device. Base station 110 is equipped with multiple (T) antennas 134a through 134t that may be used for both data transmission on the forward link and data reception on the reverse link. Terminal 150 is equipped with multiple (R) antennas 152a through 152r that may be used for data reception on the forward link but only one antenna 152a that may be used for data transmission on the reverse link. Each antenna may be a physical antenna or an antenna array. The forward link (or downlink) refers to the communication link from the base station to the terminal, and the reverse link (or uplink) refers to the communication link from the terminal to the base station.

On the forward link, at base station 110, a transmit (TX) data processor 120 receives traffic data from a data source 112, processes (e.g., formats, encodes, interleaves, and symbol maps) the traffic data in accordance with a packet format, and generates data symbols. As used herein, a data symbol is a symbol for data, a pilot symbol is a symbol for pilot, and a symbol is typically a complex value. The data symbols and pilot symbols may be modulation symbols from a modulation scheme such as PSK or QAM. Pilot is data that is known a priori by both a transmitter and a receiver. A packet format may indicate a data rate or information bit rate, a coding scheme or code rate, a modulation scheme, a packet size, and/or other parameters. A packet format may also be referred to as a rate, a transport format, or some other terminology. TX data processor 120 demultiplexes the data symbols into M streams, where 1≦M≦T and is determined by a MIMO transmission rank from a controller/processor 140. The M data symbol streams may also be referred to as data streams, spatial streams, output streams, or some other terminology.

A TX spatial processor 130 multiplexes pilot symbols with the data symbols, performs pseudo eigen-beamforming on the multiplexed data and pilot symbols as described below, and provides T output symbol streams to T transmitters (TMTR) 132a through 132t. Each transmitter 132 processes (e.g., modulates, converts to analog, filters, amplifies, and upconverts) its output symbol stream and generates a forward link signal. T forward link signals from transmitters 132a through 132t are transmitted from antennas 134a through 134t, respectively.

At terminal 150, R antennas 152a through 152r receive the T forward link signals, and each antenna 152 provides a received signal to a respective receiver (RCVR) 154. Each receiver 154 processes (e.g., filters, amplifies, downconverts, digitizes, and demodulates) its received signal, provides received data symbols to a receive (RX) spatial processor 160, and provides received pilot symbols to a channel processor 194. Channel processor 194 estimates the forward link channel response based on the received pilot symbols and provides channel estimates to RX spatial processor 160. RX spatial processor 160 performs MIMO detection on the received data symbols with the channel estimates and provides data symbol estimates. An RX data processor 170 further processes (e.g., deinterleaves and decodes) the data symbol estimates and provides decoded data to a data sink 172.

Terminal 150 may evaluate the channel conditions and send feedback information to base station 110. The feedback information may comprise the MIMO transmission rank, channel quality indicators (CQIs), other types of information, or a combination thereof. The feedback information and traffic data from a data source 180 are processed by a TX data processor 182, multiplexed with pilot symbols and spatially processed by a TX spatial processor 184, and further processed by a transmitter 154a to generate a reverse link signal, which is transmitted via antenna 152a.

At base station 110, the reverse link signal is received by T antennas 134a through 134t, processed by receivers 132a through 132t, spatially processed by an RX spatial processor 136, and further processed by an RX data processor 138 to recover the feedback information and traffic data sent by terminal 150. Controller/processor 140 controls the data transmission to terminal 150 based on the feedback information. A channel processor 144 estimates the reverse link channel response based on the received pilot symbols and provides channel estimates, which may be used for pseudo eigen-beamforming.

Controllers/processors 140 and 190 control the operation at base station 110 and terminal 150, respectively. Memories 142 and 192 store data and program codes for base station 110 and terminal 150, respectively.

In general, a terminal may have any number of transmit antennas and any number of receive antennas. A terminal may have fewer transmit antennas than receive antennas due to various reasons such as power amplifier, handheld form-factor, and/or other limitations. For clarity, much of the following description is for a terminal with a single transmit antenna and multiple receive antennas, as shown in FIG. 1.

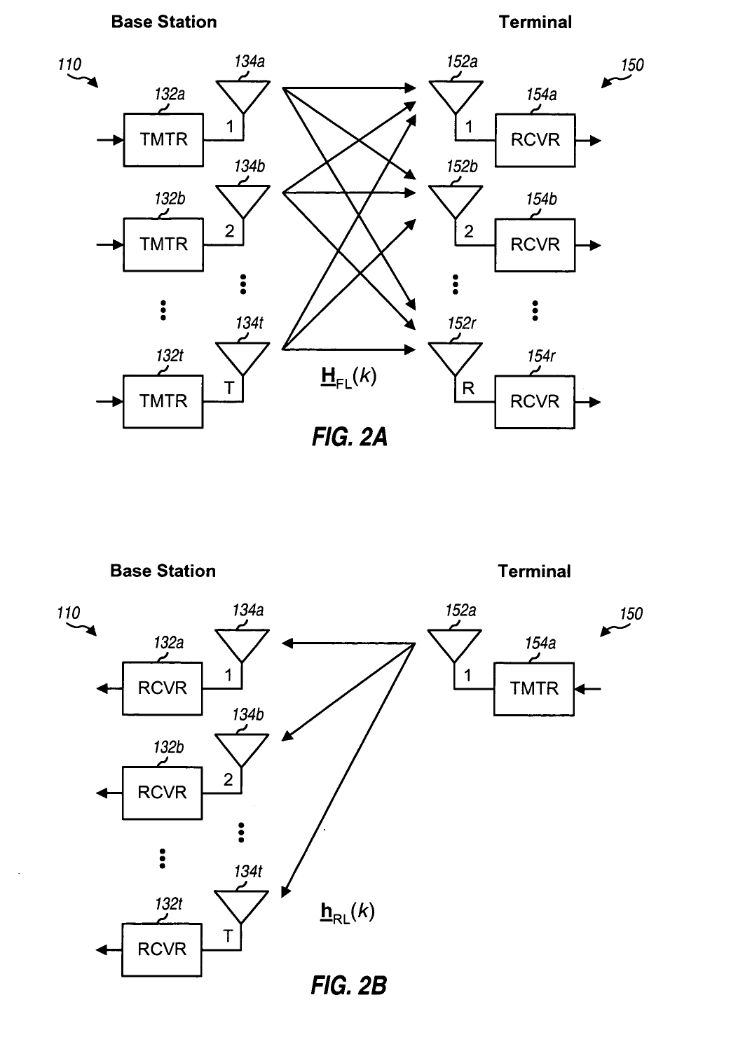

FIG. 2A shows forward link (FL) transmission from base station 110 to terminal 150. The FL transmission is sent from T antennas 134a through 134t at base station 110 and is received by R antennas 152a through 152r at terminal 150. A MIMO channel formed by the T transmit antennas and the R receive antennas may be characterized by an R×T MIMO channel response matrix H_{FL}(k) for each subcarrier k, which may be expressed as:

$${\underline{H}}_{FL} ( k ) = [ \begin{matrix}{h}_{1 , 1} ( k ) & {h}_{1 , 2} ( k ) & ⋯ & {h}_{1 , T} ( k ) \\ {h}_{2 , 1} ( k ) & {h}_{2 , 2} ( k ) & ⋯ & {h}_{2 , T} ( k ) \\ ⋮ & ⋮ & ⋰ & ⋮ \\ {h}_{R , 1} ( k ) & {h}_{R , 2} ( k ) & ⋯ & {h}_{R , T} ( k )\end{matrix} ] , k = 1 , … , K , \qquad Eq ( 1 )$$

where entry h_{i,j}(k), for i=1, . . . , R and j=1, . . . , T, is the coupling or complex gain between antenna j at base station 110 and antenna i at terminal 150 for subcarrier k. The MIMO channel may be decomposed into S spatial channels, where S≦min {T, R}. The spatial channels may also be referred to as spatial layers, layers, independent channels, and so on. S data symbol streams may be sent simultaneously on the S spatial channels.

FIG. 2B shows reverse link (RL) transmission from terminal 150 to base station 110. The RL transmission is sent from a single antenna 152a at terminal 150 and is received by T antennas 134a through 134t at base station 110. A single-input multiple output (SIMO) channel formed by the single transmit antenna and the T receive antennas may be characterized by a T×1 SIMO channel response vector h_{RL}(k) for each subcarrier k, which may be expressed as:
h_{RL}(k)=[h₁(k)h₂(k) . . . h_{T}(k)]^{T}, k=1, . . . K, Eq (2)
where entry hⱼ(k), for j=1, . . . , T, is the complex gain between the transmit antenna at terminal 150 and antenna j at base station 110 for subcarrier k, and “^{T}” denotes a transpose.

System 100 may utilize time division duplexing (TDD). With TDD, a single frequency channel is used for both the forward and reverse links. The transmission timeline may be partitioned into time intervals, with certain time intervals being used for FL transmission and other time intervals being used for RL transmission. Since one frequency channel is used for both links, the FL channel response may be assumed to be reciprocal of the RL channel response. That is, if H_{FL}(k) is the MIMO channel response matrix for the forward link, then a reciprocal channel implies that the MIMO channel response matrix for the reverse link may be given as H_{RL}(k)=H_{FL}^{T}(k). Channel reciprocity in the TDD system allows a channel response for one link to be estimated based on pilot sent on the other link. For example, the MIMO channel response for the forward link may be estimated based on pilot received on the reverse link.

If terminal 150 transmits from only one antenna, then base station 110 may obtain a SIMO channel response vector h_{RL}(k) for just the antenna used for transmission. Base station 110 may be able to estimate only one row (e.g., the first row) of the MIMO channel response matrix H_{FL}(k), as follows:
h_{FL}(k)=h_{RL}^{T}(k)·K(k), Eq (3)
where
K(k) is a T×T calibration matrix, and
h_{FL}(k) is a 1×T channel response row vector corresponding to h_{RL}(k).

In equation (3), K(k) is a diagonal matrix containing complex elements that account for differences between RF components in the transmitters and receivers at base station 110 and terminal 150. For simplicity, K(k) may be assumed to be equal to an identity matrix, or K(k)=I, in which case h_{FL}(k)=h_{RL}^{T} (k).

If the MIMO channel response matrix H_{FL}(k) is available, then H_{FL}(k) may be diagonalized with either eigenvalue decomposition or singular value decomposition to obtain S eigenmodes, where S≦min {T, R}. The eigenmodes may be viewed as orthogonal spatial channels. The eigenvalue decomposition may be expressed as:
C_{FL}(k)=H_{FL}^{H}(k)·H_{FL}(k)=V_{FL}(k)·Λ_{FL}(k)·V_{FL}^{H}(k), Eq (4)
where
C_{FL}(k) is a T×T covariance matrix of H_{FL}(k),
Λ_{FL}(k) is a T×T diagonal matrix of eigenvalues of C_{FL}(k),
V_{FL}(k) is a T×T unitary matrix of eigenvectors of C_{FL}(k), and
“^{H}” denotes a conjugate transpose.

A unitary matrix V is characterized by the property V^{H}·V=I, which means that the columns of V are orthogonal to one another and each column has unit power. The diagonal elements of Λ_{FL}(k) are eigenvalues that represent the power gains of the eigenmodes of H_{FL}(k).

Base station 110 may then perform eigen-beamforming to transmit S data symbol streams on the S eigenmodes, as follows:
x(k)=V_{FL}(k)·G(k)·s(k), Eq (5)
where
s(k) is a T×1 vector with up to S data symbols to be sent on subcarrier k,
G(k) is a T×T gain matrix with S gain values along the diagonal, and
x(k) is a T×1 vector with T output symbols for T antennas on subcarrier k.

Gain matrix G(k) determines the amount of transmit power to use for the S data symbol streams. Base station 110 may also transmit S data symbol streams on S spatial channels with other transmitter spatial processing or without any spatial processing. However, the eigen-beamforming in equation (5) generally provides better performance.

If terminal 150 transmits from only one antenna, then base station 110 can estimate only one row of H_{FL}(k). Base station 110 would then have limited channel information and would not be able to perform eigen-beamforming shown in equations (4) and (5).

In an embodiment, pseudo eigen-beamforming may be performed using limited channel information available at a transmitter. Pseudo eigen-beamforming refers to data transmission on eigenmodes determined based on limited channel information. The limited channel information may comprise long-term statistics of the MIMO channel response obtained by the transmitter, long-term statistics of the MIMO channel response obtained by a receiver and sent to the transmitter, instantaneous or short-term channel information available to the transmitter, and/or other information.

In an embodiment, pseudo eigen-beamforming is performed as follows. Base station 110 may derive an estimate of the RL channel response vector h_{RL}(k) whenever pilot is received from terminal 150 and may obtain an estimate of the corresponding FL channel response row vector h_{FL}(k), e.g., as shown in equation (3). Base station 110 may then form a T×T beam construction matrix B(k), as follows:
B(k)=[h_{FL}^{H}(k)b₂(k) . . . b_{T}(k)], Eq (6)
where bⱼ(k), for j=2, . . . , T, may be T×1 random vectors.

A set of vectors may be defined. The vectors in this set may be selected in a pseudo-random manner and used for b₂(k) through b_{T}(k). Vectors bⱼ(k) may be pseudo-random across subcarriers to achieve frequency diversity. However, randomly changing bⱼ(k) across subcarriers may result in an effective channel with too much frequency selectivity, which may degrade channel estimation performance. A trade-off may be made between channel estimation performance and frequency diversity gain by varying bⱼ(k) slowly, e.g., by applying a phase roll across the elements of each vector and/or across subcarriers.

Base station 110 may derive a beam construction matrix in other manners, e.g., by using channel information obtained by base station 110 as well as channel information received from terminal 150. For example, terminal 150 may estimate the MIMO channel response, perform eigenvalue decomposition, and derive a long-term average of the eigenvectors in V_{FL}(k). Terminal 150 may then send one or more long-term eigenvectors (e.g., the dominant long-term eigenvector with the largest eigenvalue) to base station 110. Base station 110 may then derive the beam construction matrix based on h_{RL}(k) and/or the long-term eigenvector(s) received from terminal 150.

Base station 110 may perform QR decomposition of the beam construction matrix B(k), as follows:
B(k)=Q(k)·R(k), Eq (7)
where
Q(k) is a T×T unitary matrix containing T orthogonal columns, and
R(k) is a T×T upper triangle matrix with zeros below the diagonal.

Unitary matrix Q(k) has the following form:
Q(k)=[q₁(k)q₂(k) . . . q_{T}(k)], Eq (8)
where

$${\underline{q}}_{1} ( k ) = \frac{{\underline{h}}_{FL}^{H} ( k )}{‖ {\underline{h}}_{FL}^{H} ( k ) ‖}$$

and q₁(k) through q_{T}(k) are orthogonal vectors.

Beam construction matrix B(k) includes one column for h_{FL}^{H}(k) and T−1 random vectors that are likely not orthogonal to h_{FL}^{H}(k). The QR decomposition provides unitary matrix Q(k) containing a normalized h_{FL}^{H}(k) and T−1 other vectors that are orthogonal to each other as well as h_{FL}^{H}(k). The use of T−1 random vectors for B(k) results in B(k) and Q(k) having T eigenmodes.

A long-term covariance matrix C_{BS}(k) may be derived as follows:
C_{BS}(k)=avg [symbol] Q^{H}(k)·Q(k) [symbol] , Eq (9)
where avg [symbol] [symbol] denotes an averaging operation. Base station 110 may derive Q(k) based on pilot received from one antenna of terminal 150, compute an outer product of Q(k), and average the outer product to obtain C_{BS}(k). The averaging may be performed using various averaging schemes and filters. The averaging may also be performed over time, frequency, or both time and frequency. For example, the averaging may be performed across all subcarriers.

A short-term covariance matrix C_{ST}(k) may be derived as follows:
C_{ST}(k)=h_{FL}^{H}(k)·h_{FL}(k). Eq (10)
Base station 110 may derive C_{ST}(k) based on pilot received from one transmit antenna of terminal 150. C_{ST}(k) has a single eigenmode since it is generated based on one channel response row vector h_{FL}(k).

A long-term covariance matrix C_{AT}(k) may be derived as follows:
C_{AT}(k)=avg [symbol] H_{FL}^{H}(k)·H_{FL}(k) [symbol] . Eq (11)
Terminal 150 may derive C_{AT}(k) based on pilot received from base station 150 and may send C_{AT}(k) to base station 110. Other covariance matrices may also be derived by base station 10 or terminal 150.

A transmit covariance matrix C_{TX}(k) may be derived as follows:
C_{TX}(k)=w₁·C_{BS}(k)+w₂·C_{ST}(k)+w₃·C_{AT}(k) Eq (12)
where w₁, w₂ and w₃ are weights for covariance matrices C_{BS}(k), C_{ST}(k) and C_{AT}(k), respectively. C_{TX}(k) may also be derived based solely on C_{BS}(k), based on C_{BS}(k) and other inputs, or based on any combination of channel information.

In equation (12), the weights w₁, w₂ and w₃ determine the contributions from the long-term and short-term covariance matrices to the transmit covariance matrix. Higher weight may be assigned to a covariance matrix deemed to be more reliable, lower weight may be assigned to a covariance matrix deemed to be less reliable, and a weight of zero may be assigned to a covariance matrix deemed to be totally unreliable or is unavailable. In an embodiment, the weights are fixed values and selected (e.g., via computer simulation, empirical measurements, etc.) to provide good performance for common channel conditions. In another embodiment, the weights are adjustable values that may be determined based on channel conditions. For example, the long-term covariance matrices may be given higher weights for a stationary terminal and lower weights for a mobile terminal. In general, the weights may be determined based on various factors such as mobility or Doppler, received signal quality, and so on.

For pseudo eigen-beamforming, a transmit covariance matrix may be constructed based on limited channel information that may be given in various forms such as channel response vectors, eigenvectors, covariance matrices, and so on. The channel information may also be obtained via various mechanisms such as pilot, explicit feedback, and so on. All of the available channel information may be appropriately weighted and combined to obtain the transmit covariance matrix.

Base station 110 may perform eigenvalue decomposition of C_{TX}(k) as follows:
C_{TX}(k)=V_{TX}(k)·Λ_{TX}(k)·V_{TX}^{H}(k), Eq (13)
where
Λ_{TX}(k) is a T×T diagonal matrix of eigenvalues of C_{TX}(k), and
V_{TX}(k) is a T×T unitary matrix of eigenvectors of C_{TX}(k).
   Base station 110 may perform eigenvalue decomposition periodically (e.g., whenever C_{TX}(k) is updated or after some number of updates of C_{TX}(k)) or whenever needed (e.g., when there is data to transmit). Base station 110 may then use the eigenvectors in V_{TX}(k) for data transmission to terminal 150.

In an embodiment, dynamic pseudo eigen-beamforming is performed for data transmission. Dynamic pseudo eigen-beamforming refers to data transmission on varying eigenmodes determined based on limited channel information. Dynamic pseudo eigen-beamforming may be achieved by selecting and using different eigenvectors in different time intervals and/or different subcarriers.

Each column of V_{TX}(k) is an eigenvector used to transmit on one eigenmode. The j-th column of V_{TX}(k) is associated with the j-th diagonal element of Λ_{TX}(k). The T diagonal elements of Λ_{TX}(k) are eigenvalues indicative of the power gains of the eigenmodes. The diagonal elements of Λ_{TX}(k) may be ordered from largest to smallest. The eigenvectors in V_{TX}(k) are ordered in the same manner as the diagonal elements of Λ_{TX}(k), so that each eigenvector is associated with the same eigenvalue before and after the ordering.

V_{TX}(k) contains T eigenvectors that may be used to transmit up to T data symbol streams. However, the number of data symbol streams that may be transmitted simultaneously is dependent on the number of eigenmodes of the MIMO channel, which is S≦min {T, R}. In general, M data symbol streams may be sent on M eigenmodes, where M≦S. M eigenvectors may be selected from among the T eigenvectors in various manners.

In an embodiment, the T eigenvectors in V_{TX}(k) are arranged into multiple (L) sets. In general, any number of sets may be formed, the sets may include the same or different numbers of eigenvectors, and each eigenvector may be placed in any set. In an embodiment, L≦min {T, R}, and each of the T eigenvectors is placed in one set.

In one embodiment, each set includes eigenvectors with eigenvalues that are relatively close to one another. Different sets may include eigenvectors with eigenvalues that are sufficiently different. For example, set 1 may include one or more eigenvectors with the largest eigenvalues that are close to each other, set 2 may include one or more eigenvectors with the next largest eigenvalues that are close to each other, and so on. The criteria “relatively close” and “sufficiently different” may be quantified in various manners. For example, eigenvalues may be relatively close if they are within a predetermined percentage of one another, and may be sufficiently different if they are more than the predetermined percentage from one another.

In another embodiment, set 1 includes a fixed number of eigenvectors with the largest eigenvalues, set 2 includes a fixed number of eigenvectors with the next largest eigenvalues, and so on. In yet another embodiment, the eigenvectors are binned into sets using different eigenvalue thresholds. For example, set 1 may include eigenvectors with eigenvalues larger than a first threshold, set 2 may include eigenvectors with eigenvalues between the first threshold and a second threshold, and so on. The thresholds may be fixed or adjustable values.

In the above embodiments, the L sets include eigenvectors with progressively smaller eigenvalues, with set 1 including eigenvectors with the largest eigenvalues and set L including eigenvectors with the smallest eigenvalues. The eigenvectors may also be arranged into sets in other manners.

The number of eigenmodes of the MIMO channel is referred to as the rank of the MIMO channel. The MIMO channel is considered full rank if S=min {T, R} and is less than full rank if S<min {T, R}. The rank is generally determined by channel conditions. For example, the rank is typically higher for wireless channels with rich scattering and is typically lower for spatially correlated channels and line-of-sight (LOS) channels. The rank of the MIMO channel may be predicted as described below, and M may denote the predicted rank. The predicted rank may also be referred to as the selected rank, the MIMO transmission rank, and so on. M data symbol streams may then be sent on M eigenmodes with M eigenvectors.

In an embodiment, M eigenvectors are selected from M sets of eigenvectors, one eigenvector from each set. For example, if M=1, then a single eigenvector may be selected from set 1. If M=2, then one eigenvector may be selected from set 1, and another eigenvector may be selected from set 2. For each of the M sets, different eigenvectors may be selected from the set in different time intervals. For example, one eigenvector may be selected from set 1 in one time interval, then another eigenvector may be selected from set 1 in another time interval, and so on. The eigenvectors in a given set may be selected in a pseudo-random manner (e.g., based on a pseudo-random sequence) or a deterministic manner (e.g., by cycling through the eigenvectors in the set). M new eigenvectors may be selected from the M sets at the same time, e.g., in each time interval. Alternatively, M new eigenvectors may be selected from the M sets in a staggered manner. For example, a new eigenvector may be selected from set 1 in one time interval, a new eigenvector may be selected from set 2 in the next time interval, and so on.

As a specific example, base station 110 may be equipped with T=8 antennas, terminal 150 may be equipped with R=2 antennas, and the highest possible rank would be two. V_{TX}(k) would contain eight eigenvectors that may be binned into two or more sets, e.g., L=3 sets. In this example, set 1 may include two eigenvectors v₁(k) and v₂(k) having eigenvalues that are close to each other, set 2 may include three eigenvectors v₃(k), v₄(k) and v₅(k) having eigenvalues that are close to each other, and set 3 may include three eigenvectors v₆(k), v₇(k) and v₈(k) having eigenvalues that are close to each other. If M=1, then set 1 is used for transmission. v₁(k) may be selected from set 1 in one time interval, v₂(k) may be selected in another time interval, v₁(k) may be selected in the next time interval, and so on. If M=2, then sets 1 and 2 are used for transmission. v₁(k) may be selected from set 1 and v₅(k) may be selected from set 2 in one time interval, v₂(k) may be selected from set 1 and v₃(k) may be selected from set 2 in another time interval, v₁(k) may be selected from set 1 and v₄(k) may be selected from set 2 in the next time interval, and so on. Since the maximum value of M is two, set 3 is not used in this example. The eigenvectors in set 3 may have eigenvalues that are too low to merit use of these eigenvectors.

Other embodiments of forming sets of eigenvectors and selecting eigenvectors from the sets are also possible and are within the scope of the invention. In an embodiment, one eigenvector is selected from each of the M sets selected for use, as described above. In another embodiment, multiple eigenvectors may be selected from a given set. In an embodiment, different eigenvectors are selected from the sets in different time intervals. In another embodiment, new eigenvectors are selected if certain events occur, e.g., if the received signal quality degrades with the current eigenvectors, if a packet is decoded in error, and so on. The eigenvectors may also be dynamically varied across time and/or frequency in other manners.

The L sets of eigenvectors may be viewed as covering different subspaces of the MIMO channel. Subspaces with larger eigenvalues may deliver more gain than subspaces with smaller eigenvalues. The embodiments described above select subspaces according to the strength of the eigenvalues, with the number of subspaces being determined by the predicted rank M of the MIMO channel.

Each eigenvector corresponds to a beam. If some eigenvectors have eigenvalues that are close to one another, then the choice of the beam(s) within the subspace spanned by these eigenvectors may be varied in a pseudo-random or deterministic manner across time and/or frequency. Using specific eigenvectors with eigenvalues that are close to one another may not provide significant gain while the resultant fixed beam directions may reduce diversity. Varying the eigenvectors over time and/or frequency may improve diversity, which may be beneficial considering that the eigenvectors are obtained from long-term statistics of the MIMO channel and hence may or may not accurately reflect the current MIMO channel.

Base station 110 may perform pseudo eigen-beamforming to transmit M data symbol streams on M eigenmodes, as follows:
x_{M}(k)=V_{M}(k)·G_{M}(k)·s_{M}(k), Eq (14)
where
s_{M}(k) is an M×1 vector with M data symbols to be sent on subcarrier k,
G_{M}(k) is an M×M gain matrix with M gain values along the diagonal,
V_{M}(k) is a T×M matrix with M eigenvectors selected for use, and
x_{M}(k) is a T×1 vector with T output symbols for T antennas on subcarrier k.

Terminal 150 receives symbols from the R receive antennas, which may be expressed as:
r_{M}(k)=H_{FL}(k)·V_{M}(k)·G_{M}(k)·s_{M}(k)+n(k)=
=H_{M}(k)·G_{M}(k)·s_{M}(k)+n(k), Eq (15)
where
H_{M}(k)=H_{FL}(k)·V_{M}(k) is an R×M effective channel response matrix for subcarrier k,
r_{M}(k) is an R×1 vector of received symbols for subcarrier k, and
n(k) is an R×1 noise vector for subcarrier k.
   For simplicity, the noise may be assumed to be additive white Gaussian noise (AWGN) with a zero mean vector and a covariance matrix of n(k)=σₙ²·I, where σₙ² is the variance of the noise. Matrices V_{M}(k) and H_{M}(k) may contain a single column if M=1.

Terminal 150 may perform MIMO detection using various techniques known in the art. In an embodiment, terminal 150 performs minimum mean square error (MMSE) MIMO detection. Terminal 150 may derive an M×R MMSE spatial filter matrix M_{M}(k) for each subcarrier k, as follows:
M_{M}(k)=D_{M}(k)·[H_{M}^{H}(k)·H_{M}(k)+σₙ²·I]⁻¹·H_{M}^{H}(k), Eq (16)
where D_{M}(k)=[diag{[Hₘ^{H}(k)·H_{M}(k)+σₙ²·I]⁻¹·H_{M}^{H}(k)·H_{M}(k)}]⁻¹ is a diagonal matrix of scaling values used to obtain normalized estimates of the data symbols.

Terminal 150 may then perform MIMO detection as follows:
ŝ_{M}(k)=M_{M}(k)·r_{M}(k), Eq (17)
where ŝ_{M}(k) is an M×1 vector of data symbol estimates for subcarrier k.

In an embodiment, terminal 150 predicts the rank of the MIMO channel. The predicted rank M determines the number of data symbol streams to transmit simultaneously and the number of eigenvectors to use for data transmission. In an embodiment, terminal 150 also estimates the received signal quality, which may be quantified by signal-to-noise ratio (SNR), signal-to-noise-and-interference ratio (SINR), energy-per-symbol-to-noise ratio (Es/No), and so on. For clarity, SNR is used for signal quality in the description below.

In an embodiment, rank prediction is performed as follows. Terminal 150 estimates the MIMO channel response matrix H_{FL}(k) based on pilot received from base station 110. Terminal 150 then forms beam construction matrix B(k), e.g., using h_{FL}(k), which is one row of H_{FL}(k). Terminal 150 then derives Q(k), C_{TX}(k), and V_{TX}(k) in the same manner as base station 110.

In an embodiment, rank prediction is achieved by evaluating the performance of different possible ranks and selecting the rank with the best or near best performance. Performance may be quantified by various metrics such as channel capacity, throughput, signal quality, and so on. For clarity, the following description assumes that R≦T and that the highest possible rank is R.

The performance of each possible rank m, where m=1, . . . , R, may be determined as follows. First, an R×m effective channel response matrix Hₘ(k) for rank m is determined as follows:
Hₘ(k)=H_{FL}(k)·Vₘ(k), Eq (18)
where Vₘ(k) is a T×m matrix containing m eigenvectors selected from V_{TX}(k) assuming that rank m is used for data transmission. The effective channel response Hₘ(k) includes the actual MIMO channel response H_{FL}(k) and the eigenvectors Vₘ(k) used by base station 110. Terminal 150 may estimate Hₘ(k) directly if base station 110 transmits pilot using V_{TX}(k). Alternatively, terminal 150 may estimate H_{FL}(k), then derive V_{TX}(k) in the same manner as base station 110, and then compute Hₘ(k) based on H_{FL}(k) and V_{TX}(k).

Terminal 150 determines the SNR of each subcarrier of each eigenmode. SNR is dependent on the MIMO detection technique used by terminal 150. If terminal 150 uses MMSE MIMO detection as shown in equation (16), then a matrix Qₘ(k) for rank m may be derived as:
Qₘ(k)=[Hₘ^{H}(k)·Hₘ(k)+σₙ²·I]⁻¹·Hₘ^{H}(k)·Hₘ(k) Eq (19)

The SNR for rank m may be expressed as:

$${SNR}_{m , i} ( k ) = \frac{{q}_{m , i} ( k )}{1 - {q}_{m , i} ( k )} , for i = 1 , … , m , \qquad Eq ( 20 )$$

where
q_{m,i}(k) is the i-th diagonal element of Qₘ(k) for subcarrier k, and
SNR_{m,i}(k) is the SNR of data symbol stream i for subcarrier k.
   SNR may be computed in other manners for other MIMO detection techniques.

In an embodiment, rank prediction is performed for a single codeword (SCW) mode that uses a single packet format for all M data symbol streams. For the SCW mode, the average SNR of all m data symbol streams for rank m, SNR_{avg,m}(k), may be expressed as:

$${SNR}_{avg , m} ( k ) = \frac{1}{m} \cdot {\sum }_{i = 1}^{m} {SNR}_{m , i} ( k ) . \qquad Eq ( 21 )$$

The average SNR of each subcarrier k may be mapped to capacity. The capacities of all K subcarriers may then be accumulated to obtain an average capacity C_{avg,m} for rank m, as follows:

$${C}_{avg , m} = {\sum }_{k = 1}^{K} {log}_{2} [ 1 + η \cdot {SNR}_{avg , m} ( k ) ] , \qquad Eq ( 22 )$$

where η<1.0 is a penalty factor that accounts for various factors such as modulation scheme, coding scheme, code rate, packet size, and so on. Capacity may also be determined based on other capacity functions or look-up tables. The average capacity C_{avg,m} may be adjusted to account for various factors such as losses due to coding scheme, channel estimation errors, interference variation, and so on.

For rank prediction based on capacity, the total capacity C_{total,m} for each rank m may be determined as follows:
C_{total,m}=m·C_{avg,m}. Eq (23)

The rank with the largest total capacity may then be selected as follows:

$$M = arg {max}_{m ∈ \{ 1 , … , R \}} ( {C}_{total , m} ) . \qquad Eq ( 24 )$$

Alternatively, the lowest rank with a total capacity that is within a predetermined percentage of the largest total capacity may be selected. A lower rank is generally more robust against deleterious channel conditions and channel estimation errors. Thus, if a lower rank can achieve a total capacity that is close to the largest total capacity, then the lower rank may be selected for use.

For rank prediction based on throughput, an effective SNR may be computed for each rank m as follows:
SNR_{eff,m}=10 log₁₀(2^{C}^{_{avg,m}}−1). Eq (25)

A packet format is selected for each rank based on the effective SNR. The selected packet format for each rank has the largest throughput and a required SNR that is less than the effective SNR. The total throughput TP_{total,m} for each rank m may then be determined as follows:
TP_{total,m}=m·TPₘ, Eq (26)
where TPₘ is the throughput of the packet format selected for rank m.

The rank with the largest total throughput may then be selected as follows:

$$M = arg {max}_{m ∈ \{ 1 , … , R \}} ( {TP}_{total , m} ) . \qquad Eq ( 27 )$$

Alternatively, the lowest rank with a total throughput that is within a predetermined percentage of the largest total throughput may be selected.

Terminal 150 may quantize the effective SNR to a predetermined number of bits to obtain a CQI for the selected rank M. Terminal 150 may then send the selected rank M and the CQI to base station 110. Base station 110 may use the selected rank to determine the number of data symbol streams to transmit to terminal 150. Base station 110 may use the CQI to determine the packet format to use for the data symbol streams sent to terminal 150.

Rank prediction may also be performed for a multiple codeword (MCW) mode that may use a different packet format for each data symbol stream. For each candidate rank m, the capacity or throughput of each data symbol stream may be computed, and the total capacity or total throughput may be determined by summing the m capacities or throughputs for the m data symbol streams. The rank may then be selected based on the total capacity or total throughput. A CQI may also be determined for each data symbol stream in the selected rank M. More than one CQI may be generated and reported if M is greater than one.

Pseudo eigen-beamforming may be used with rank prediction, and the synergy between the two may improve data transmission performance. Pseudo eigen-beamforming may also be used for the SCW and MCW modes as well as other modes. Pseudo eigen-beamforming may also be used without rank prediction or with a simplified version of rank prediction. For example, the rank may be set as M=min {T, R}, and data may be transmitted with the maximum possible rank. The rank may also be selected based on the reported CQI. For example, the highest possible rank may be used if the CQI exceeds a first threshold, the next lower rank may used if the CQI is between the first threshold and a second threshold, and so on.

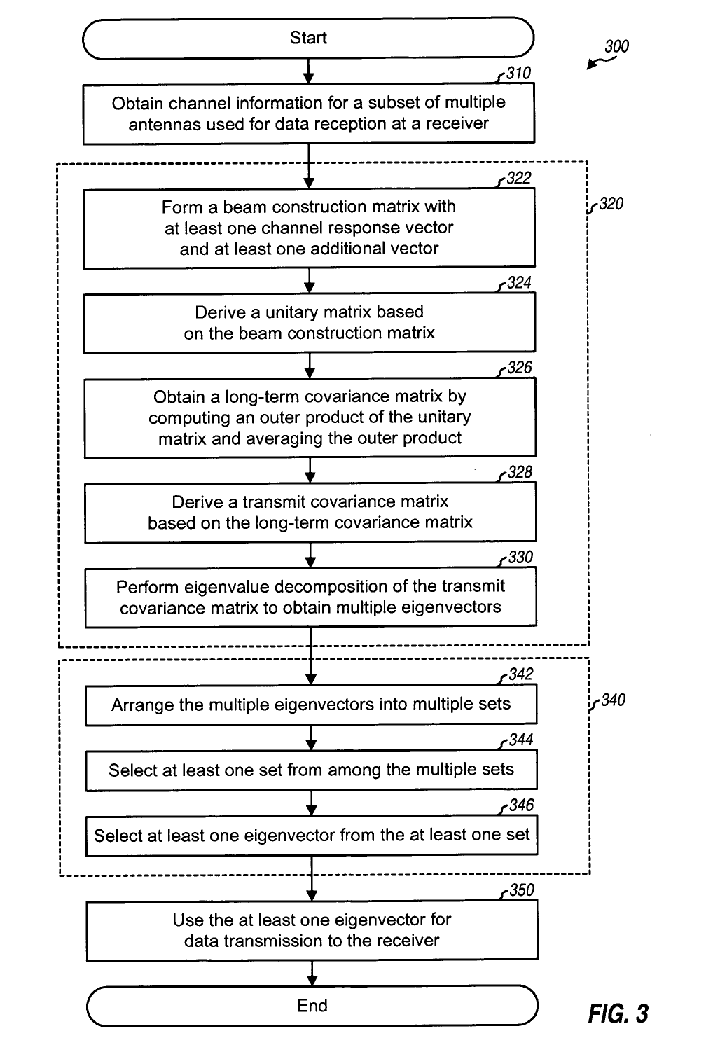

FIG. 3 shows an embodiment of a process 300 performed by a transmitter (e.g., a base station) for data transmission. Channel information for a subset of multiple antennas used for data reception at a receiver (e.g., a terminal) is initially obtained (block 310). The channel information may comprise at least one channel response vector for at least one antenna, which is a subset of the multiple antennas at the receiver. Multiple eigenvectors are derived based on the channel information (block 320). In an embodiment of block 320, a beam construction matrix is formed with the at least one channel response vector and at least one additional vector, e.g., as shown in equation (6) (block 322). A unitary matrix is then derived based on the beam construction matrix, e.g., by performing QR decomposition as shown in equation (7) (block 324). A long-term covariance matrix is obtained by computing an outer product of the unitary matrix and averaging the outer product, e.g., as shown in equation (9) (block 326). The outer product may be averaged across time intervals, subcarriers, or both time intervals and subcarriers. A transmit covariance matrix is then derived based on the long-term covariance matrix obtained by the transmitter in block 326, a second long-term covariance matrix obtained from the receiver, a short-term covariance matrix derived based on the at least one channel response vector, other information, or any combination thereof (block 328). Eigenvalue decomposition of the transmit covariance matrix is performed to obtain the multiple eigenvectors (block 330).

At least one eigenvector is selected from among the multiple eigenvectors (block 340). In an embodiment of block 340, the multiple eigenvectors are arranged into multiple sets (block 342). For example, the multiple eigenvectors may be ordered based on their eigenvalues, and the multiple sets may be filled one set at a time and in a sequential order with the ordered eigenvectors. The multiple sets may be associated with different non-overlapping ranges of eigenvalues, and each set may include one or more eigenvectors with eigenvalues within the associated range of eigenvalues. Alternatively, each set may include a predetermined number of eigenvectors. Each eigenvector may be included in one set. At least one set is selected from among the multiple sets (block 344). At least one eigenvector is then selected from the at least one set (block 346). For example, the number of sets to select in block 344 may be determined by the MIMO transmission rank, and one eigenvector may be selected from each set. Different subsets of at least one eigenvector may be selected in a pseudo-random or deterministic manner from among the multiple eigenvectors or the at least one set in different time intervals. The at least one eigenvector for each time interval is used for data transmission to the receiver in that time interval (block 350).

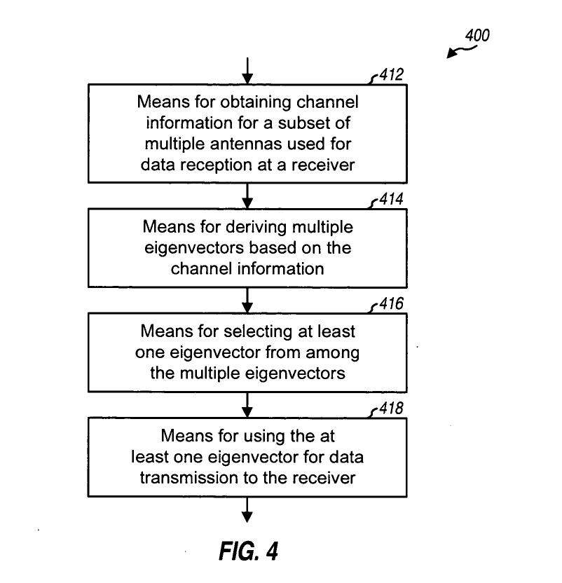

FIG. 4 shows an embodiment of an apparatus 400 for data transmission. Apparatus 400 includes means for obtaining channel information for a subset of multiple antennas used for data reception at a receiver (block 412), means for deriving multiple eigenvectors based on the channel information (block 414), means for selecting at least one eigenvector from among the multiple eigenvectors (block 416), and means for using the at least one eigenvector for data transmission to the receiver (block 418).

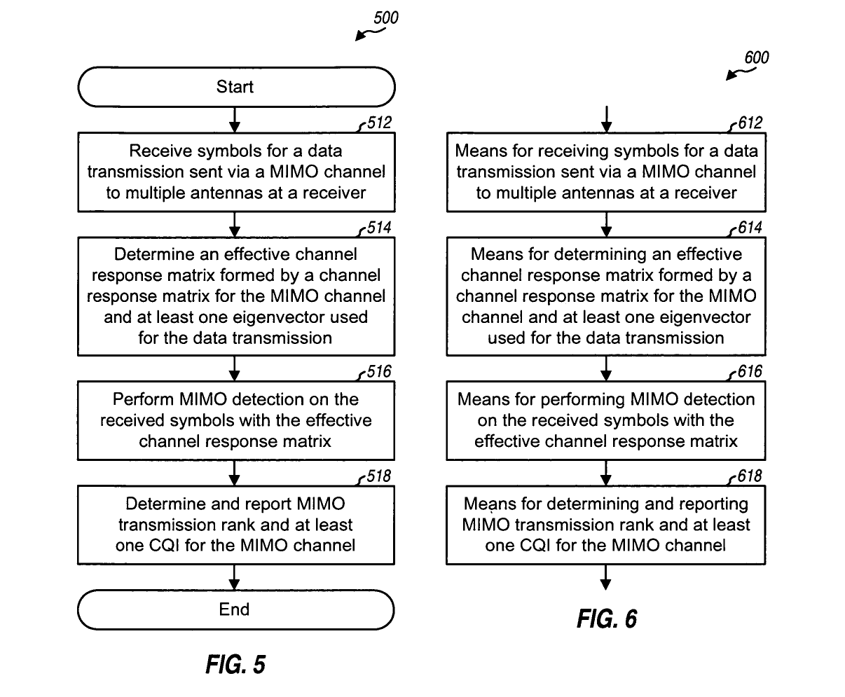

FIG. 5 shows an embodiment of a process 500 performed by a receiver (e.g., a terminal) for data reception. Symbols are received for a data transmission sent via a MIMO channel to multiple antennas at the receiver (block 512). An effective channel response matrix is determined (block 514). The effective channel response matrix is formed by a channel response matrix for the MIMO channel and at least one eigenvector used for data transmission and selected from among multiple eigenvectors derived based on channel information for a subset of the multiple antennas. In an embodiment of block 514, a channel response matrix is derived, and the channel information comprises at least one channel response vector from the channel response matrix. The eigenvector(s) used for the data transmission may be determined, e.g., as described above for blocks 320 and 340 in FIG. 3. The effective channel response matrix may then be derived based on the channel response matrix and the eigenvector(s) used for data transmission, e.g., as shown in equation (15). The effective channel response matrix may also be derived directly based on pilot from the transmitter.

MIMO detection is then performed on the received symbols with the effective channel response matrix (block 516). In an embodiment of block 516, a spatial filter matrix is derived based on the effective channel response matrix, e.g., as shown in equation (16), and MIMO detection is performed with the spatial filter matrix, e.g., as shown in equation (17).

The MIMO transmission rank is determined, e.g., based on a performance metric such as capacity or throughput, as described above (block 518). At least one CQI for the MIMO channel and corresponding to the MIMO transmission rank is also determined (block 518). A long-term covariance matrix may also be derived based on the channel response matrix. The MIMO transmission rank, CQI(s), long-term covariance matrix, and/or other information may be sent to the transmitter (block 518).

FIG. 6 shows an embodiment of an apparatus 600 for data reception. Apparatus 600 includes means for receiving symbols for a data transmission sent via a MIMO channel to multiple antennas at a receiver (block 612), means for determining an effective channel response matrix (block 614), means for performing MIMO detection on the received symbols with the effective channel response matrix (block 616), and means for determining and reporting the MIMO transmission rank, at least one CQI for the MIMO channel, and/or other information (block 618).

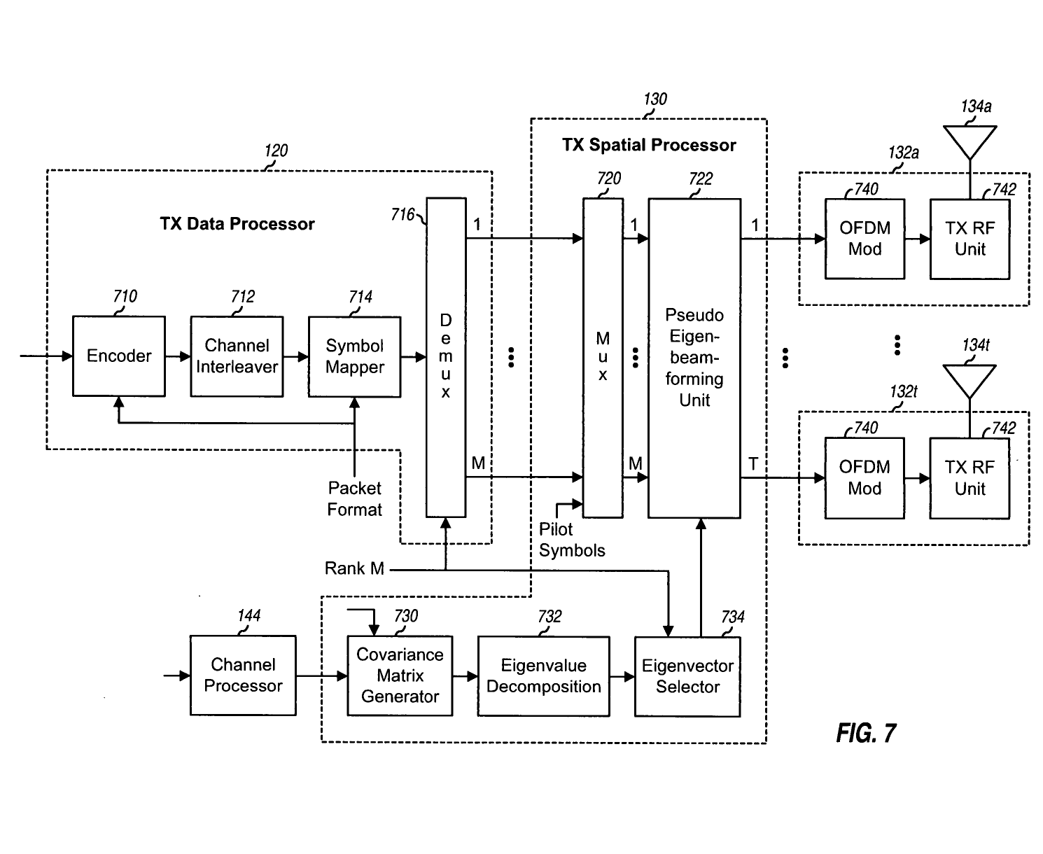

FIG. 7 shows a block diagram of an embodiment of TX data processor 120, TX spatial processor 130, and transmitters 132a through 132t at base station 110. Within TX data processor 120, an encoder 710 encodes traffic data in accordance with a coding scheme and generates code bits. The coding scheme may include a Turbo code, a convolutional code, a low density parity check (LDPC) code, a cyclic redundancy check (CRC) code, a block code, and so on, or a combination thereof. A channel interleaver 712 interleaves (or reorders) the code bits based on an interleaving scheme and provides interleaved bits. A symbol mapper 714 maps the interleaved bits in accordance with a modulation scheme and provides data symbols. A demultiplexer (Demux) 716 demultiplexes the data symbols into M streams, where M is the MIMO transmission rank.

Within TX spatial processor 130, a multiplexer (Mux) 720 receives the M data symbol streams and maps the data symbols and pilot symbols to the proper subcarriers in each symbol period. A pseudo eigen-beamforming unit 722 multiplies the data and/or pilot symbols for each subcarrier k with M eigenvectors from an eigenvector selector 734. Unit 722 provides T output symbol streams to T transmitters 132a through 132t.

A covariance matrix generator 730 receives an RL channel response vector for each antenna used for transmission by terminal 150 and may also receive other channel information sent by terminal 150. Generator 730 generates a transmit covariance matrix based on all of the available information, e.g., as shown in equations (6) through (12). A unit 732 performs eigenvalue decomposition of the transmit covariance matrix, e.g., as shown in equation (13), and provides T eigenvectors for T eigenmodes of each subcarrier. Eigenvector selector 734 receives the MIMO transmission rank M and selects M eigenvectors from among the T eigenvectors, e.g., based on any of the embodiments described above. For example, selector 734 may arrange the T eigenvectors into L sets, select the first M sets among the L sets, and select M different eigenvectors from the M sets in different time intervals.

Each transmitter 132 includes an OFDM modulator (Mod) 730 and a TX radio frequency (RF) unit 732. OFDM modulator 730 receives an output symbol stream and generates OFDM symbols. TX RF unit 732 processes the OFDM symbols and generates a forward link signal.

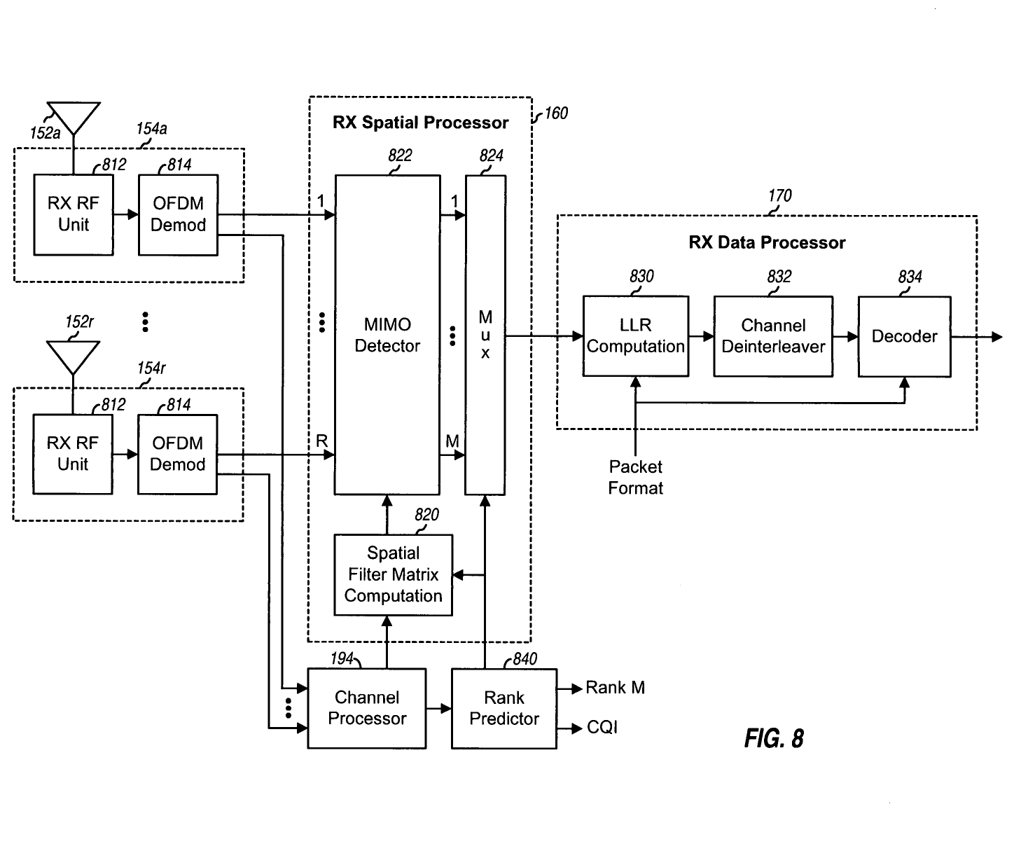

FIG. 8 shows a block diagram of an embodiment of receivers 154a through 154r, RX spatial processor 160, and RX data processor 170 at terminal 150. Each antenna 152 receives the forward link signals from base station 110 and provides a received signal to a respective receiver 154. Each receiver 154 includes an RX RF unit 812 and an OFDM demodulator (Demod) 814. RX RF unit 812 processes the received signal and provides samples. OFDM demodulator 814 performs OFDM demodulation on the samples, provides received data symbols to RX spatial processor 160, and provides received pilot symbols to channel processor 194. Channel processor 194 derives an estimate of the MIMO channel response based on the received pilot symbols.

Within RX spatial processor 160, a computation unit 820 derives a spatial filter matrix for each subcarrier used for transmission based on a MIMO channel response matrix for that subcarrier and the eigenvector(s) used for transmission, e.g., as shown in equation (16). A MIMO detector 822 performs MIMO detection for each subcarrier with the spatial filter matrix for that subcarrier, e.g., as shown in equation (17). A multiplexer 824 multiplexes the data symbol estimates for the M streams.

Within RX data processor 170, a unit 830 computes log-likelihood ratios (LLRs) of the data symbol estimates. A channel deinterleaver 832 deinterleaves the LLRs in a manner complementary to the interleaving by channel interleaver 712. A decoder 834 decodes the deinterleaved LLRs and provides decoded data.

A rank predictor 840 estimates the SNRs for different possible ranks based on the MIMO channel response matrices for different subcarriers, e.g., as shown in equations (19) and (20). Rank predictor 840 also determines the MIMO transmission rank M to use for data transmission and the CQI, e.g., as described above. Rank predictor 840 may be implemented by controller/processor 190 in FIG. 1.

For clarity, much of the description above is for data transmission from base station 110 to terminal 150. The transmission techniques may also be used for data transmission from terminal 150 to base station 110. For RL transmission, the processing described above for base station 110 may be performed by a terminal, and the processing described above for terminal 150 may be performed by a base station. In general, the transmission techniques may be used for data transmission from any transmitter to any receiver.

The transmission techniques described herein may be used for various operating scenarios. The techniques may be used when one station (e.g., a terminal) has more receive antennas than transmit antennas. The techniques may also be used when multiple clusters of correlated antennas are present, with low correlation between clusters. The techniques may also be used for a station with an angular spread that induces moderate level of correlation among the antennas. The techniques may also be used for other operating scenarios.

The transmission techniques described herein may be implemented by various means. For example, these techniques may be implemented in hardware, firmware, software, or a combination thereof. For a hardware implementation, the processing units at a transmitter or a receiver may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the transmission techniques may be implemented with modules (e.g., procedures, functions, and so on) that perform the functions described herein. The firmware and/or software codes may be stored in a memory (e.g., memory 142 or 192 in FIG. 1) and executed by a processor (e.g., processor 140 or 190). The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
at least one processor configured to obtain channel information for a subset of multiple antennas used for data reception at a receiver, to derive multiple eigenvectors based on the channel information, to select at least one eigenvector from among the multiple eigenvectors, and to use the at least one eigenvector for data transmission to the receiver; and
a memory coupled to the at least one processor.

2. The apparatus of claim 1, wherein the at least one processor is configured to obtain at least one channel response vector for at least one antenna used for data reception, to derive a transmit covariance matrix based on the at least one channel response vector, and to derive the multiple eigenvectors based on the transmit covariance matrix, wherein the channel information comprises the at least one channel response vector, and wherein the at least one antenna is a subset of the multiple antennas.

3. The apparatus of claim 2, wherein the at least one processor is configured to form a beam construction matrix based on the at least one channel response vector and at least one additional vector, to derive a unitary matrix based on the beam construction matrix, to compute an outer product of the unitary matrix, to average the outer product to obtain a long-term covariance matrix, and to derive the transmit covariance matrix based on the long-term covariance matrix.

4. The apparatus of claim 3, wherein the at least one processor is configured to average the outer product across multiple time intervals, across multiple frequency subcarriers, or across both multiple time intervals and multiple frequency subcarriers.

5. The apparatus of claim 3, wherein the at least one processor is configured to form the transmit covariance matrix further based on a second long-term covariance matrix obtained from the receiver.

6. The apparatus of claim 3, wherein the at least one processor is configured to derive a short-term covariance matrix based on the at least one channel response vector, and to form the transmit covariance matrix further based on the short-term covariance matrix.

7. The apparatus of claim 1, wherein the at least one processor is configured to determine a multiple-input multiple-output (MIMO) transmission rank for a MIMO channel formed with the multiple antennas, and wherein the number of eigenvectors selected from the multiple eigenvectors is determined by the MIMO transmission rank.

8. The apparatus of claim 1, wherein the at least one processor is configured to select different subsets of at least one eigenvector from among the multiple eigenvectors in different time intervals, and to transmit data in each time interval using the subset of at least one eigenvector selected for the time interval.

9. The apparatus of claim 1, wherein the at least one processor is configured to arrange the multiple eigenvectors into multiple sets, to select at least one set from among the multiple sets, and to select the at least one eigenvector from the at least one set.

10. The apparatus of claim 9, wherein each of the multiple eigenvectors is included in one of the multiple sets.

11. The apparatus of claim 9, wherein the at least one processor is configured to arrange the multiple eigenvectors into the multiple sets based on eigenvalues for the multiple eigenvectors.

12. The apparatus of claim 9, wherein the at least one processor is configured to order the multiple eigenvectors based on eigenvalues for the multiple eigenvectors, and to fill the multiple sets, one set at a time and in a sequential order, with the ordered eigenvectors.

13. The apparatus of claim 9, wherein the multiple sets are associated with different non-overlapping ranges of eigenvalues, and wherein each set includes at least one eigenvector with eigenvalue within an associated range of eigenvalues.

14. The apparatus of claim 9, wherein each of the multiple sets includes a predetermined number of eigenvectors.

15. The apparatus of claim 9, wherein the at least one processor is configured to determine a multiple-input multiple-output (MIMO) transmission rank for a MIMO channel formed with the multiple antennas, wherein the number of sets selected is equal to the MIMO transmission rank, and wherein one eigenvector is selected from each of the at least one set.

16. The apparatus of claim 9, wherein the at least one processor is configured to select different eigenvectors from the at least one set in different time intervals, and to transmit data in each time interval using the at least one eigenvector selected for the time interval.

17. The apparatus of claim 16, wherein the at least one processor is configured to select different eigenvectors from the at least one set in a pseudo-random manner.

18. A method comprising:
obtaining channel information for a subset of multiple antennas used for data reception at a receiver;
deriving multiple eigenvectors based on the channel information;
selecting at least one eigenvector from among the multiple eigenvectors; and
using the at least one eigenvector for data transmission to the receiver.

19. The method of claim 18, wherein the channel information comprises at least one channel response vector for at least one antenna used for data reception, and wherein the deriving the multiple eigenvectors comprises
forming a beam construction matrix based on the at least one channel response vector and at least one additional vector,
deriving a unitary matrix based on the beam construction matrix,
computing an outer product of the unitary matrix,
averaging the outer product to obtain a long-term covariance matrix,
deriving a transmit covariance matrix based on the long-term covariance matrix, and
deriving the multiple eigenvectors based on the transmit covariance matrix.

20. The method of claim 18, wherein the selecting the at least one eigenvector comprises selecting different subsets of at least one eigenvector from among the multiple eigenvectors in different time intervals, and wherein the using the at least one eigenvector for data transmission comprises transmitting data in each time interval using the subset of at least one eigenvector selected for the time interval.

21. The method of claim 18, wherein the selecting the at least one eigenvector comprises
arranging the multiple eigenvectors into multiple sets,
selecting at least one set from among the multiple sets, and
selecting the at least one eigenvector from the at least one set.

22. The method of claim 21, wherein the selecting the at least one eigenvector comprises selecting different eigenvectors from the at least one set in different time intervals, and wherein the using the at least one eigenvector for data transmission comprises transmitting data in each time interval using the at least one eigenvector selected for the time interval.

23. An apparatus comprising:
means for obtaining channel information for a subset of multiple antennas used for data reception at a receiver;
means for deriving multiple eigenvectors based on the channel information;
means for selecting at least one eigenvector from among the multiple eigenvectors; and
means for using the at least one eigenvector for data transmission to the receiver.

24. The apparatus of claim 23, wherein the channel information comprises at least one channel response vector for at least one antenna used for data reception, and wherein the means for deriving the multiple eigenvectors comprises
means for forming a beam construction matrix based on the at least one channel response vector and at least one additional vector,
means for deriving a unitary matrix based on the beam construction matrix,
means for computing an outer product of the unitary matrix,
means for averaging the outer product to obtain a long-term covariance matrix,
means for deriving a transmit covariance matrix based on the long-term covariance matrix, and
means for deriving the multiple eigenvectors based on the transmit covariance matrix.

25. The apparatus of claim 23, wherein the means for selecting the at least one eigenvector comprises means for selecting different subsets of at least one eigenvector from among the multiple eigenvectors in different time intervals, and wherein the means for using the at least one eigenvector for data transmission comprises means for transmitting data in each time interval using the subset of at least one eigenvector selected for the time interval.

26. The apparatus of claim 23, wherein the means for selecting the at least one eigenvector comprises
means for arranging the multiple eigenvectors into multiple sets,
means for selecting at least one set from among the multiple sets, and
means for selecting the at least one eigenvector from the at least one set.

27. The apparatus of claim 26, wherein the means for selecting the at least one eigenvector comprises means for selecting different eigenvectors from the at least one set in different time intervals, and wherein the means for using the at least one eigenvector for data transmission comprises means for transmitting data in each time interval using the at least one eigenvector selected for the time interval.

28. A computer-readable medium including instructions stored thereon, comprising:
a first instruction set for obtaining channel information for a subset of multiple antennas used for data reception at a receiver;
a second instruction set for deriving multiple eigenvectors based on the channel information;
a third instruction set for selecting at least one eigenvector from among the multiple eigenvectors; and
a fourth instruction set for using the at least one eigenvector for data transmission to the receiver.

29. An apparatus comprising:
at least one processor configured to receive symbols for a data transmission sent via a multiple-input multiple-output (MIMO) channel to multiple antennas at a receiver, to determine an effective channel response matrix formed by a channel response matrix for the MIMO channel and at least one eigenvector used for the data transmission and selected from among multiple eigenvectors derived based on channel information for a subset of the multiple antennas, and to perform MIMO detection on the received symbols with the effective channel response matrix; and
a memory coupled to the at least one processor.

30. The apparatus of claim 29, wherein the at least one processor is configured to derive the channel response matrix, and wherein the channel information comprises at least one channel response vector from the channel response matrix.

31. The apparatus of claim 30, wherein the at least one processor is configured to derive a transmit covariance matrix based on the at least one channel response vector, to derive the multiple eigenvectors based on the transmit covariance matrix, to select the at least one eigenvector from among the multiple eigenvectors, and to derive the effective channel response matrix based on the channel response matrix and the at least one eigenvector.

32. The apparatus of claim 31, wherein the at least one processor is configured to form a beam construction matrix with the at least one channel response vector and at least one additional vector, to derive a unitary matrix based on the beam construction matrix, to compute an outer product of the unitary matrix, to average the outer product to obtain a long-term covariance matrix, and to derive the transmit covariance matrix based on the long-term covariance matrix.

33. The apparatus of claim 29, wherein the at least one processor is configured to derive a channel response matrix for the MIMO channel, to derive a long-term covariance matrix based on the channel response matrix, and to send the long-term covariance matrix to a transmitter.

34. The apparatus of claim 29, wherein the at least one processor is configured to determine a MIMO transmission rank, to determine at least one channel quality indicator (CQI) for the MIMO channel, and to send the MIMO transmission rank and the at least one CQI to a transmitter.

35. The apparatus of claim 29, wherein the at least one processor is configured to determine performance metrics for a plurality of ranks, each rank indicative of a different number of data streams to send simultaneously via the MIMO channel, and to select a rank from among the plurality of ranks based on the performance metrics.

36. The apparatus of claim 29, wherein the at least one processor is configured to determine capacity of the MIMO channel for each of a plurality of ranks and to select a rank based on capacities of the MIMO channel for the plurality of ranks.

37. The apparatus of claim 29, wherein the at least one processor is configured to determine throughput for each of a plurality of ranks and to select a rank based on throughputs for the plurality of ranks.

38. A method comprising:
receiving symbols for a data transmission sent via a multiple-input multiple-output (MIMO) channel to multiple antennas at a receiver;
determining an effective channel response matrix formed by a channel response matrix for the MIMO channel and at least one eigenvector used for the data transmission and selected from among multiple eigenvectors derived based on channel information for a subset of the multiple antennas; and
performing MIMO detection on the received symbols with the effective channel response matrix.

39. The method of claim 38, wherein the determining the effective channel response matrix comprises
deriving the channel response matrix,
deriving a transmit covariance matrix based on at least one channel response vector from the channel response matrix,
deriving the multiple eigenvectors based on the transmit covariance matrix,
selecting the at least one eigenvector from among the multiple eigenvectors, and
deriving the effective channel response matrix based on the channel response matrix and the at least one eigenvector.

40. The method of claim 38, further comprising:
determining a MIMO transmission rank for the MIMO channel;
determining at least one channel quality indicator (CQI) for the MIMO channel; and
sending the MIMO transmission rank and the at least one CQI to a transmitter.

41. An apparatus comprising:
means for receiving symbols for a data transmission sent via a multiple-input multiple-output (MIMO) channel to multiple antennas at a receiver;
means for determining an effective channel response matrix formed by a channel response matrix for the MIMO channel and at least one eigenvector used for the data transmission and selected from among multiple eigenvectors derived based on channel information for a subset of the multiple antennas; and
means for performing MIMO detection on the received symbols with the effective channel response matrix.

42. The apparatus of claim 41, wherein the means for determining the effective channel response matrix comprises
means for deriving the channel response matrix,
means for deriving a transmit covariance matrix based on at least one channel response vector from the channel response matrix,
means for deriving the multiple eigenvectors based on the transmit covariance matrix,
means for selecting the at least one eigenvector from among the multiple eigenvectors, and
means for deriving the effective channel response matrix based on the channel response matrix and the at least one eigenvector.

43. The apparatus of claim 41, further comprising:
means for determining a MIMO transmission rank for the MIMO channel;
means for determining at least one channel quality indicator (CQI) for the MIMO channel; and
means for sending the MIMO transmission rank and the at least one CQI to a transmitter.

44. A computer-readable medium including instructions stored thereon, comprising:
a first instruction set for directing reception of symbols for a data transmission sent via a multiple-input multiple-output (MIMO) channel to multiple antennas at a receiver;
a second instruction set for determining an effective channel response matrix formed by a channel response matrix for the MIMO channel and at least one eigenvector used for the data transmission and selected from among multiple eigenvectors derived based on channel information for a subset of the multiple antennas; and
a third instruction set for performing MIMO detection on the received symbols with the effective channel response matrix.
